(19) United States
(12) Patent Application Publication
(10) Pub. No.: US 2002/0031114 A1
(43) Pub. Date: Mar. 14, 2002

(54) Priority packet transmission system for telephony, latency-sensitive data, best-effort data and video streams in a shared transmission media such as passive coax distribution

(75) Inventors: John B. Terry, Cumming, GA (US); Robert P. Basil, Lawrenceville, GA (US)

Correspondence Address: DANIELS & DANIELS, P.A., SUITE 200, GENERATION PLAZA, 1822 N.C. HIGHWAY 54, EAST, DURHAM, NC, 27713, US

(73) Assignee: CoaXmedia, Inc., Cumming, GA

(21) Appl. No.: 09/908,754

(22) Filed: Jul. 19, 2001

Related U.S. Application Data
(60) Provisional application No. 60/219,886, filed on Jul. 21, 2000.

(51) Int. Cl. H04L 12/66; H04J 1/02

(52) U.S. Cl. 370/352; 370/493

(57) ABSTRACT

In a shared transmission media communication system with an upstream frequency and a downstream frequency carrying telephony such as TDM PCM data in addition to other data types, it is useful to use a master frame format that sends downstream the TDM PCM data sub-packets to a set of downstream modem devices and to provide the downstream modem devices with staggered times to respond. The master frame then continues to send downstream data types such as video that do not trigger a response from the downstream modems during a period of time allocated for the downstream modems to send upstream transmissions of TDM PCM. A set of rules can be implemented within this system to favor the transmission of higher priority data types while preventing any data type from taking too much of the downstream bandwidth.

### Cross-Reference to Related Application

This application claims priority to a provisional application filed Jul. 21, 2000 and having Ser. No. 60/219,886.

An earlier filed patent application by common assignee coaXmedia, Inc. for High Speed Data Communication Over Local Coaxial Cable sets forth the field of this invention and a description of the coaXmedia solution to the problem. The application number is Ser. No. 09/482,836. The '836 application is hereby incorporated by reference in its entirety.

Subsequent to the filing of the '836 application, another application assigned to common assignee coaXmedia, Inc was filed for Architecture and Method for Automated Distributed Gain Control for Internet Communications for MDUs and Hotels (application Ser. No. 09/818,378 based on Provisional Application No. 60/193,855). The '855 application is relevant to the discussion that follows and is hereby incorporated by reference in its entirety.

The present application represents an improvement over the previously filed applications so to the extent that there is a conflict between the text or figures incorporated by reference and the text or figures of this disclosure, the contents of this disclosure would, of course, prevail.

For the convenience of the reader, various acronyms and other terms used in the field of this invention are defined at the end of the specification in a glossary. Other terms used by the applicant to define the operation of the inventive system are defined throughout the specification. For the convenience of the reader, applicant has added a number of topic headings to make the internal organization of this specification apparent and to facilitate location of certain discussions. These topic headings are merely convenient aids and not limitations on the text found within that particular topic.

In order to promote clarity in the description, common terminology for components is used. The use of a specific term for a component suitable for carrying out some purpose within the disclosed invention should be construed as including all technical equivalents which operate to achieve the same purpose, whether or not the internal operation of the named component and the alternative component use the same principles. The use of such specificity to provide clarity should not be misconstrued as limiting the scope of the disclosure to the named component unless the limitation is made explicit in the description or the claims that follow.

### BACKGROUND

The '855 application describes a system that allows the connection of devices such as personal computers to special modems that connect to a legacy tree and branch coax network in a hotel, Multiple Dwelling Units (MDUs), or analogous building. The system described used bandwidth in two ranges outside of the range used for cable TV for a downstream channel and an upstream channel. As this is a tree and branch network, all communications heading downstream must identify which modem device (or devices) are being addressed since all modem devices will receive the communication. Conversely, the communication from the many individual modem devices to the upstream end of the network must be controlled so that only one modem device is sending an upstream communication at any one time in order to avoid bus contention.

The situation addressed by both the '855 application and the current invention is shown generally in FIG. 1. A coax tree and branch network 50 connects the head end of the network 40 to a set of splitter devices. Details on the implementation of the system upstream of the head end of the tree and branch network 40 are described in the referenced applications and do not need to be developed here.

A partial set of splitter devices is shown in FIG. 1 as splitters 52, 54, and 56. Thus, the signal at head end 40 is present at the input to modem devices 60, 62, 64, 66, 68, and 70. Output jacks on the modem devices allow for connection of televisions (71,75, 80, 84, 86, and 90), devices such as personal computers (72, 81, 87, and 92), and telephones (74, 77, 78, 82, 85, and 88). Note that two telephones 77 and 78 are connected to modem device 64. Each of the two telephones is connected to its own telephone port. As the cable TV signal does not need to be processed within the modem devices, this signal can be taken from an external diplexer positioned upstream of the modem device rather than as shown from an output on the modem device.

The '378 application includes an RF coax transmission system in which all information flowing downstream (from 40 to the modem devices 60, 62, 64, 66, 68, and 70) is formatted according to DVB/MPEG-2 structure to facilitate multimedia applications. The formats of the downstream and upstream transmission used in the coaXmedia system are illustrated in FIG. 2.

The downstream transmission frame 100 is 204 bytes long. The downstream transmission frame 100 is comprised of: a SYNC byte 104 (of value 47 hex for frame or packet start identification and B8 hex, i.e. inverted 47 hex for multi-frame identification); followed by a payload of 187 bytes; and a FEC field 120 of 16 bytes. In MPEG2 applications two bytes following the sync byte are used for packet identification 108 (“PID”). In the coaXmedia system (and in more recently evolving standards) an additional byte is reserved for packet type identification 112. Thus as shown in FIG. 2, the payload 116 is 184 bytes as three bytes have been used for PID 108 and type 112. The FEC field 120 is followed by a SYNC byte 104 from the next frame.

For information flowing upstream (from the client) the same type of formatting is used but the payload length is variable and the FEC field optional. Thus, the upstream data frame 150 is comprised of: an 8 byte preamble 152; a SYNC byte 154; a PID 158; packet type identification byte 162; length field 164; and variable length payload 168. FIG. 2 includes idle periods 180.

The traffic to be carried has the following characteristics and needs:

TDM PCM Telephony traffic requires constant bit-rate transmission, typically 64 Kb/s. When carried by a statistical packet transport system, telephony requires regular scheduling of packets, identified by source and destination.

Low-latency IP comprised of Internet Protocol (IP) Telephony, or multimedia traffic containing telephony or audio components, requires minimum latency and minimum delay variation. For telephony, the access portions of the IP network should not introduce more than 10 ms to 20 ms delay. IP telephony thus requires temporal priority in a mixed traffic type packet network, usually accomplished by tagging such packets and separation and prioritization of buffering.

MPEG2 video streaming is comprised of “I” frames (whole picture update), “B” frames (bi-directionally predictive update) and “P” frames (predictive update). Synchronized audio components are included and have separate packet identification (PID). MPEG2 is somewhat tolerant of delay and delay variation due to buffering at the receiver/decoder but is less tolerant of missing or mis-ordered packets. Thus bit-rate capacity management is necessary to provide acceptable service, i.e. no freeze-frames or other visible artifacts.

Best-effort IP traffic, typically TCP/IP traffic, is tolerant of packet loss or mis-ordering due to network link or buffer restrictions. Transactions are usually initiated using “slow-start” procedures, i.e. the traffic starts slowly and increases in traffic bit-rate until packet loss is encountered, at which point the traffic rate is adjusted to maximize rate of transmission through the available and often variable network capacity. Loss or delay of acknowledgment packets can cause drastic loss of apparent capacity. IP traffic transactions, while dominantly downstream bandwidth intensive, can be dominantly upstream bandwidth intensive as end-users now often include servers.

### BRIEF SUMMARY OF THE INVENTION

The objective of this patent application is to provide for a mix of heterogeneous traffic; TDM PCM telephony (DS-0) channels, low latency IP data packets identified by tags provided in IEEE 802.1p, best effort IP data packets and MPEG-2 digital video streams. For purposes of this application and claims that follow, all traffic fall into one of the categories of: telephony (including TDM PCM), low latency IP (including telephony implemented over IP), video (including the various versions of MPEG), best efforts IP, and null. A master frame is a superset of frames.

### BRIEF DESCRIPTION OF THE DRAWINGS

FIG. 1 shows a tree and branch network connected to a series of modem devices, where the modem devices are connected to combinations of televisions, devices such as personal computers, and telephones.

FIG. 2 shows the standard downstream and upstream transmission formats.

FIG. 3 illustrates the loading of seven TDM PCM sub-packets into the payload sections of three downstream transmission frames.

FIG. 4 illustrates the loading of the TDM PCM sub-packets for a single telephone into an upstream transmission frames.

FIG. 5 illustrates the prioritization used to position data frames with various types of data within two master frames.

### DESCRIPTION OF THE PREFERRED EMBODIMENT

To facilitate re-ordering of the different “data” types (or classes) of downstream traffic each “data” type is provided with a separate buffer at the server end of the system. In such a system packets of one type will normally overtake those of other types.

In the upstream (from client) direction, transmission is only permitted upon receiving a downstream command, or implied command.

A TDM PCM telephony channel (international standard) comprises one speech sample value byte every 125 μs (125 microseconds). In this proposed system, typically 64 such bytes are formed into a word that must be transmitted in each direction every 8 ms (8 milliseconds).

In order that client upstream TDM PCM traffic can be returned in bursts from different clients without contention, some idle time between upstream packets, called padding, must be provided to accommodate differences in coax distance delay between client modems and the server modem. In a symmetrical bit-rate two-way transmission system corresponding padding time must also be included in the downstream direction. In the case where FEC is used in the downstream direction but not in the upstream direction, the per-packet FEC transmission time will likely exceed the required upstream padding time—thus no additional downstream time padding is required.

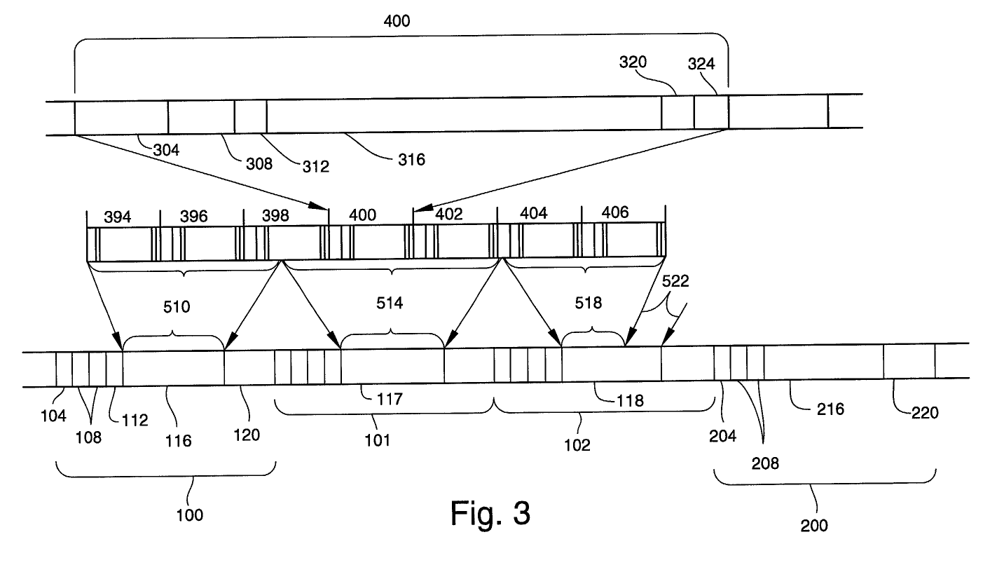

In the more likely case where the downstream transmission bit-rate significantly exceeds that of the upstream transmission bit-rate, the percentage of downstream transmission time required for padding would create gross wastage of transmission efficiency. However, where the mix of downstream traffic types includes downstream-only traffic types-such as that of MPEG2 video streaming (or standard IP data packets with no response from the client modem commanded), it is preferable that such downstream-only traffic be substituted for padding, thus restoring the overall downstream transmission efficiency. The downstream TDM PCM telephony transmission format using this approach is illustrated in FIG. 3.

Downstream Transmission

The top line of FIG. 3 provides a detailed look at a TDM PCM telephony sub-packet 400. This sub-packet is further comprised of: a two byte preamble 304; a four byte address 308 (MAC address plus Telephone Port number—necessary for modems with more than one telephone port); a length value 312; a variable length payload of TDM PCM traffic 316; a two byte time to respond value 320; and a two byte CRC value 324. The term sub-packet is used since there is not a one to one ratio between TDM PCM sub-packets and the downstream frames. Typically a packet is an indivisible unit that is addressed to a specific modem or group of modems. The address of a packet is always decoded at the beginning of a frame. Sub-packets are typically smaller than frames and thus can be concatenated together with other sub-packets to fill up frames more efficiently. The address of every sub-packet is always decoded, whether at the beginning, middle or end of the frame.

In a preferred embodiment, the portion of the MAC address that is common to all modem devices from a given company can be deleted from the front end of the MAC address so that the space allocated for the downstream address is reduced.

Using this approach, a clock pulse which occurs regularly at 8 ms intervals is used to signal that, upon completion of the MPEG2 frame currently being transmitted, the next MPEG2 frame(s) will contain the downstream TDM PCM traffic destined for all coaXmedia modems. The start of the first PCM TDM-carrying frame defines the start time of a coaXmedia “master frame”. The TDM PCM traffic is transmitted without any padding followed by, for example, sufficient MPEG2 streaming video packets to allow time for all of the responding TDM PCM traffic-carrying modems to return their upstream traffic at a relatively lower speed.

In order to coordinate the timing of responses from the TDM PCM carrying coaXmedia modems, calculated time-to-respond values 320 must be included in each downstream TDM PCM sub-packet as shown at the top of FIG. 3. Such an approach allows each downstream sub-packet to be of any length, thus offering different classes of latency performance or bit-rates on an individual per-call basis or even the variation of these parameters during a call to accommodate temporary over-traffic conditions.

As illustrated in FIG. 3, the multiple TDM PCM telephony channels (in the example, blocks of 64 bytes) of downstream TDM PCM telephony are identified (destination address prefix) then concatenated and sent in one or more regular MPEG2-sized downstream packets.

As seen in FIG. 3, sub-packet 400 is concatenated in sequence with sub-packets 394, 396, 398, 402, 404, and 406. Note that sub-packet 394 does not have a preamble as there is no preamble on the first sub-packet. The concatenated set of seven TDM PCM sub-packet is divided into pieces 510, 514 and 518 of appropriate size to be carried in the payloads of the MPEG/DVD frames. Thus piece 510 is placed into payload 116 of downstream frame 100.

Frame 100 is marked as Type-Master Frame a TDM voice reference, with ID set to MPEG null. The identification of this packet is a master frame allows the modem devices to recognize the start of the next 8 ms time period. Note that the slight jitter that arises sending the beginning of the next master frame after completion of transmission of the current frame rather than immediately upon the receipt of the 8 ms clock pulse is relatively small and can be addressed through conventional means.

Piece 514 is placed into payload 117 of downstream frame 101. Piece 518 partially fills payload 118 of frame 102 leaving a portion 522 of payload 118 unused. Note that one of the reasons why the downstream transmission is more efficient than upstream transmission is that seven downstream TDM PCM sub-packets are being carried in somewhat less than three downstream frames. The upstream response will take seven upstream frames, one from each modem (ignoring possible economies from combining sub-packets from different ports on the same modem). Each of the upstream transmissions from the seven modems will have staggered start times to provide guard band periods in order to avoid upstream contention.

Frames 101 and 102 are marked as Type-TDM Continue with PID-MPEG null.

Downstream frame 102 is followed by an MPEG frame 200. The MPEG frame 200 is comprised of: a sync byte 204, two bytes for Packet Identification 208 (“PID”); a payload of MPEG2/4 216; and a FEC field 220. The PID value for frame 200 is “video stream”.

The transmission of a frame containing MPEG data does not require a response from the downstream modem device and thus does not risk channel contention with upstream TDM PCM traffic. If no MPEG data is available for transmission, then other data types that do not trigger a response would be sent during this buffer period. If no such data is available, then null frames would be sent until the completion of the time allocated for upstream transmissions of TDM PCM traffic.

As illustrated in FIG. 3 with sub-packet 398, the division into pieces may separate the beginning from the end of a particular TDM PCM sub-packet. At the downstream end of this tree and branch network, the payloads from the MPEG/DVD frames are concatenated. Each modem then recognizes the sub-packets addressed to that modem and then processes those sub-packets.

Upstream Transmission

Each Telephony-responding modem returns a 64 byte block of PCM samples which represent 8 ms of speech. Some guard time is needed to prevent contention of returning signals due to timeshift caused by different path lengths (a near modem could start transmitting before the signal from a far modem has completely reached the central modem).

Each downstream Telephony packet has appended to it a value which tells the destination modem at what time to respond. Since the downstream transmission speed is usually much faster than the upstream transmission speed, all of the downstream TDM PCM will have been received well before all of the Telephony-carrying modems have completed their response. Thus only other types of traffic which do not require a response may be sent in the downstream direction until the upstream Telephony packets have been transmitted. In fact, modems should not be allowed to transmit non-TDM PCM traffic upstream until all of the Telephony responses have completed.

One method of ensuring system integrity for handling Telephony is to use one bit in the downstream “type” identifier byte to indicate whether the upstream PCM TDM traffic has completed. An alternative is to merely use a type identifier to indicate the start of a master frame (which by implication would be start of PCM TDM) and a second type for each successive frame containing PCM TDM sub-packets. The latter type would be—TDM Continue. The start of the first frame that is not either the start of a master frame or type TDM continue, would indicate the end of PCM TDM sub-packets as this data type is only sent at the front of a master frame.

Synchronization

To facilitate coordination of upstream TDM PCM traffic sub-packet (burst) timing, all coaXmedia modems must have an equal sense of time or common clock, relative to the downstream TDM PCM transmission master frame timing. To achieve this, the start of the master frame is identified by a unique value of MPEG2 format packet Type which, when received by each TDM PCM traffic carrying modem, initiates their internal master-frame time counters. Thus the time-to-respond values sent in the downstream TDM PCM voice sub-packets, when matched with the value of such counters contained in each coaXmedia modem, trigger the sending of TDM PCM voice sub-packets in the upstream direction.

Upstream Format

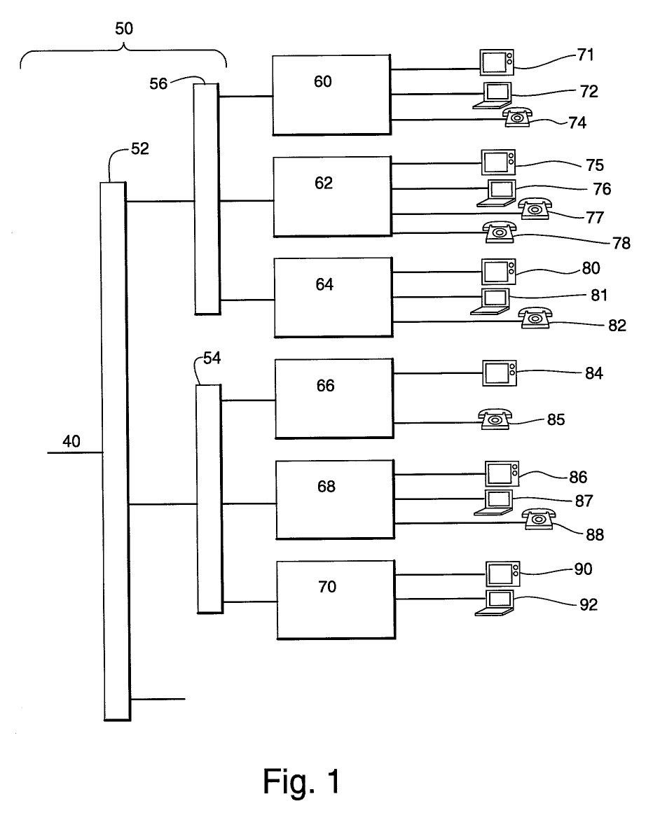

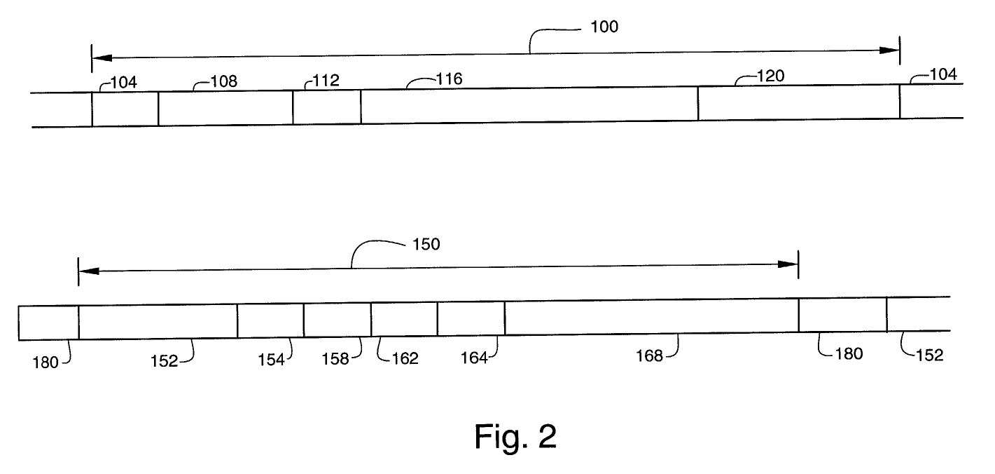

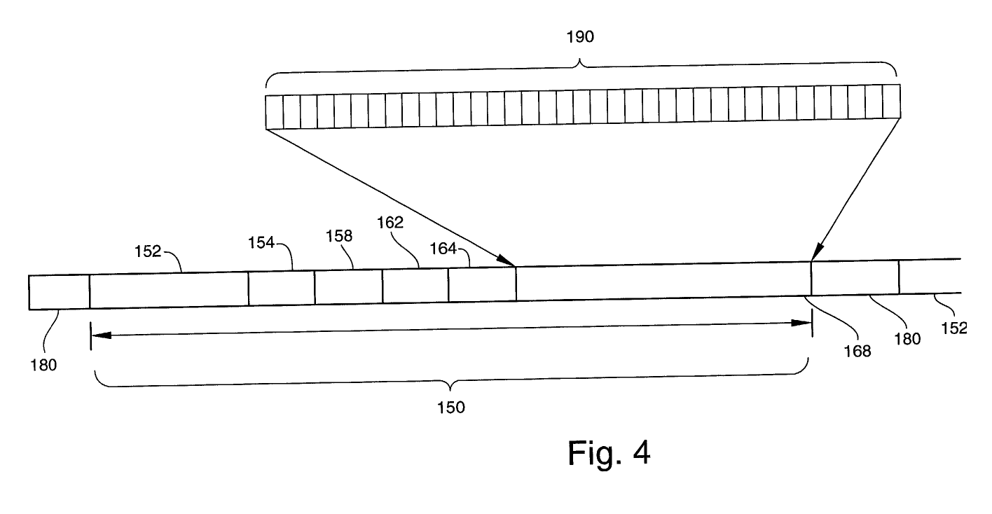

The format of an upstream TDM PCM telephony traffic sub-packet is illustrated in FIG. 4. This is an extension of the frame shown in FIG. 2. The upstream data frame 150 is comprised of: the 8 byte preamble 152; the SYNC byte 154; the PID 158; the packet type identification byte 162; the length field 164; and the variable length payload 168. As shown in FIG. 4, the variable length payload 168 carries bytes of PCM telephony 190 from the telephone call associated with a particular downstream modem and port. When the frame type is telephony, the PID 158 is soft modem I/D plus Telephone Port number in order to distinguish between two telephone ports on the same modem as shown in FIG. 1 for modem device 62 and telephones 77 and 78. The PID could use the same MAC address (either full MAC address or shortened MAC address) as described for the downstream frames. The preferred embodiment uses an abbreviated address (soft modem ID) that is mapped to the MAC address. The purpose is to reduce the overhead in each individual frame to increase the efficiency of data transmission in the upstream direction since the upstream direction is inherently less efficient than downstream transmission.

FIG. 4 includes idle time 180 before packet 150 and the start of the preamble 152 of the next packet (not shown in entirety).

Time coordination from use of time-to-respond values will thus prevent any transmission contention in the upstream direction. In the event that a downstream TDM PCM voice sub-packet contains an error, as detected by the inbuilt CRC checksum or other means, no upstream sub-packet trigger is generated and thus the upstream period contains no transmission. This is important, since an error in the downstream time-to-respond value could potentially create a response at an incorrect time and thus potentially create contention with the upstream sub-packet of another coaXmedia modem.

Traffic Type Prioritization

In the preferred embodiment, TDM PCM sub-packets and any MPEG2 packets used to provide downstream padding are given an over-riding priority at the start of the TDM PCM master frame. Next, low-latency IP traffic, such as IP voice or IP multimedia containing a voice component, is transmitted from its own buffer in preference to traffic contained in best-effort IP or video streaming buffers at any time during the remainder of the master frame. When the low-latency IP traffic buffer is empty, traffic from the video-streaming buffer (if any remains) is transmitted. In a preferred embodiment, video streaming packets, which enter this buffer subsequently during the current master frame, wait their turn until the next master frame, thus ensuring that MPEG2 packet bunching does not gain priority over the IP traffic. Finally, while there is time left in the master frame, best-effort IP packets are transmitted. Traffic management of the video streaming and telephony voice components may be used to ensure that there is sufficient capacity remaining for the IP packets.

In the preferred embodiment, there is only a single buffer for MPEG2 video streaming. Some of the content of this buffer is output to provide time padding while waiting for the upstream TDM PCM traffic to complete. The remainder of this buffer content is output after the low-latency traffic buffer has exhausted. Any time left after the MPEG2 video streaming buffer has exhausted is used to send best-effort IP data.

In the event that the low latency IP traffic transmission period, within a master frame, could result in insufficient time to exhaust the MPEG2 buffer prior to the end of the master frame, priority would be exclusively switched to the MPEG2 video traffic. Having said this, some reserve time should be left in the frame to send a small amount of best-effort IP data packets. The aggregate amounts of MPEG2 video traffic and TDM PCM telephony traffic allowed in each master frame is defined by a management function in order that this traffic cannot starve the IP traffic capacity.

MPEG2 video traffic entering its buffer after the start of a master frame is not transmitted until the next master frame. This is not the case for low-latency IP traffic—low-latency IP traffic entering its buffer during a current master frame may be output during that same master frame, in order to minimize latency as much as possible.

There can also be an arbitrary limit set on the amount of low-latency traffic that is given transmission priority. It is more of an IP network decision as to whether the low-latency traffic can also consume the transmission capacity of the best-effort IP data packets. The coaXmedia system can be provided with appropriate rules by network management.

A variety of rules may be applied to traffic prioritization within the system described, once the TDM PCM telephony traffic has been transmitted. One of the novel aspects of the present disclosure is the provisioning of the multiple buffers and means for applying rules to their output prioritization.

Management of the relative priorities between low-latency IP and best-effort traffic IP is dealt with externally to the coaXmedia system-i.e. at a network level (802.1P/802.1Q QOS protocols). In the event that the network offers more traffic than the coaXmedia system provides, traffic may be denied entry to buffers, which are likely to overflow. This action is normal in an IP network and is dealt with by existing IP network protocols.

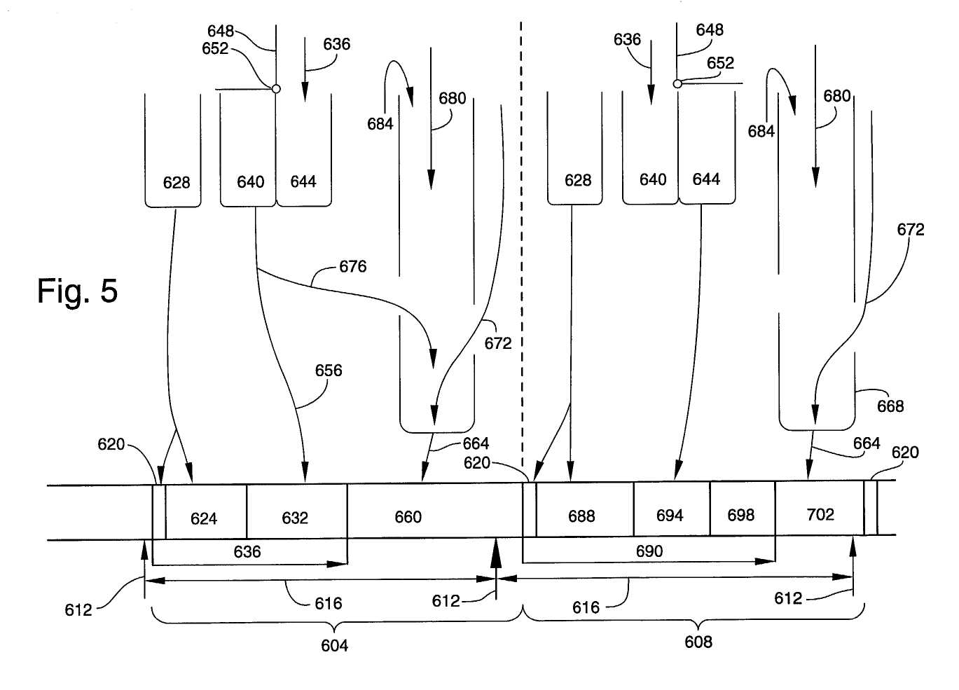

FIG. 5 is an illustration of many of the concepts relating to prioritization within the master frame. Note that FIG. 5 is intended to illustrate concepts and is not meant to be an accurate scale drawing of actual frames or buffers. Portions of the master frames are enlarged to allow labeling.

FIG. 5 shows two complete master frames (sometimes called super frames). These are master frames 604 and 608. Additional pieces of adjacent master frames are also visible. Each master frame starts shortly after the periodic clock pulse 612. In one preferred embodiment, the interval 616 between clock pulses is 8 milliseconds.

As discussed in connection with FIG. 3, the first frame 620 sent after the clock pulse 612 is marked as Type-Master Frame. As discussed above, the payload of the first frame 620 and in the frames that follow carry the TDM PCM frames as payloads. Thus, the TDM PCM frames for all current TDM PCM sessions is carried in frame 620 and in the frames in the section 624 of master frame 604. The queue of TDM PCM frames is represented by buffer 628. Master frame section 632 follows section 624 and is sized to ensure that downstream data transmissions sent to the modem devices are of a type that do not require an upstream response, until the end of time interval 636. Time interval 636 is set to allow various individual downstream modem devices sufficient time to send upstream TDM PCM transmissions in accordance with the designated time to respond values sent to each modem device. As discussed above the aggregate time for the upstream transmission of the TDM PCM data with the guard bands necessary to prevent contention is much longer than the time necessary for the downstream transmission of the TDM PCM data.

Rather than fill master frame segment 632 with null frames, the segment 632 takes frames from the queue of MPEG frames (or other data types that do not impose an obligation to respond). In the preferred embodiment, MPEG data frames 636 that arrive after the start of a new master frame is queued until the next master frame. This concept is illustrated by a double buffer in FIG. 5. For master frame 604, MPEG buffer A 640 is closed to the receipt of new MPEG data frames but supplies MPEG data frames for transmission in master frame 604. MPEG buffer B 644 captures MPEG data frames 636 and holds the frames for the duration of master frame 604.

At the next pulse 612, figuratively the buffer lid 648 rotates about hinge 652 so that MPEG buffer B 644 is now the source of MPEG frames for master frame 608 but is closed to the receipt of newly arriving MPEG frames 636. MPEG buffer A 640 is now isolated from master frame 608 but open for receipt of newly arriving MPEG frames 636.

Returning now to master frame 604, section 632 is filled with MPEG frames 656 without exhausting the supply in MPEG buffer A 640.

The remainder 660 of master frame 604 is comprised of a series of frames 664 carrying frames with various data types from multi-tiered queue 668. The highest priority payload is low latency IP 672. Whenever the supply of low latency IP 672 is exhausted, then the remaining MPEG data frames 676 are drained. Best effort IP packets 680 are drained from queue 668 and sent in frame payloads when there is not any higher priority data types. If the queue 668 is drained of all data types before the next pulse 612, then null frames 684 are used. The supply of null frames is endless as they are created upon demand.

Note that low latency IP 672 jumps to the front of the queue, even after the start of transmission of MPEG frames 676, best effort IP 680, or null frames 684. Likewise best effort IP packets 680 received when the master frame is being loaded with null frames 684 will be given priority over null frames.

Moving now to master frame 608, the amount of TDM PCM sub-packets from buffer 628 is greater in this master frame than in master frame 604. The difference in the amount of TDM PCM sub-packets is magnified to help illustrate the concepts of the invention, but the amount of TDM PCM sub-packets to be carried by the master frames will vary over time as more TMD PCM sessions are added or dropped.

The increase in TDM PCM payloads to carry in first frame 620 and master frame segment 688 in master frame 608 as compared to master frame 604 accounts for the increase in time allocated for upstream TDM PCM traffic in time interval 690 as compared to time interval 636. In this case, MPEG buffer B 644 is drained before the end of time interval 690. The segment 698 corresponding to remaining time interval 690 is filled with null frames. As MPEG buffer B 644 is empty, there is no contribution of MPEG frames to multi-tiered buffer 668 for use in master frame segment 702.

Those skilled in the art will recognize that the methods and apparatus of the present invention has many applications and that the present invention is not limited to the specific examples given to promote understanding of the present invention. Moreover, the scope of the present invention covers the range of variations, modifications, and substitutes for the system components described herein, as would be known to those of skill in the art. For example, this invention works well for TDM PCM data but would work equally well for other data types including other telephony data types where it is important to stagger the upstream transmissions and send selected types of downstream traffic while the upstream transmissions are transpiring.

MPEG frames and null frames are types of burden-free data, but this is not an exhaustive list. Burden-free data is data that can be sent to the downstream device without placing a burden on the downstream device to respond. While this inventive concept is explained in terms of these two types of burden-free data, other types of burden-free data could be used, including new evolutions in the MPEG standard as well as other streaming video or streaming audio standards. The other types of burden-free data could include the subset of IP data packets that does not require a response from the downstream device.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

Glossary of Abbreviations

| | |
|---|---|
| FEC | Forward Error Correction |
| IP | Internet Protocol |
| MPEG | Motion Picture Experts Group (Digital Video Standards) |
| MAC | Media Access Control (Modem/adapter physical address) |
| PCM | Pulse Code Modulation (of Telephony speech in this document) |
| PID | Packet Identifier |
| QOS | Quality of Service |
| TDM | Time Division Multiplexed |

What is claimed is:

1. A method of transmitting telephony data and other data from an upstream device to at least two downstream devices on a shared transmission media, the method comprising:
A) transmitting a first frame downstream from the upstream device to the at least two downstream devices, the first frame comprising:
a. a type identifier to identify this frame as a first frame in a master frame;
b. at least one full sub-packet of telephony data addressed to one of the at least two downstream devices;
B) transmitting a set of continuation frames downstream from the upstream device to the at least two downstream devices, the continuation frames each comprising:
a. a type identifier to identify the frame as a continuation frame carrying additional telephony data;
b. at least a portion of one full sub-packet of telephony data for use by at least one of the downstream devices;
C) transmitting burden-free frames from the upstream device to the downstream devices until the end of a calculated time, the calculated time being a time sufficient for the downstream devices to send telephony data upstream, the burden-free frames placing no burden on the downstream devices for an upstream transmission;
D) transmitting unrestricted frames from the upstream device to the downstream devices after the end of the calculated time and before the end of the master frame time interval, wherein the transmitted frames are not restricted to burden-free frames.

2. The method of claim 1 wherein a first source of burden-free frames is video frames to be delivered to at least one of the downstream devices.

3. The method of claim 2 wherein null frames are sent as burden-free frames after the first source of frames is exhausted.

4. The method of claim 2 wherein the first source of burden-free frames is limited to video frames queued before the start of the current master frame.

5. The method of claim 1 wherein unrestricted frames include two types of data selected from the group of video data, low latency IP data, and best efforts data.

6. The method of claim 1 wherein the unrestricted frames are sent according to a priority associated with the data type, such that data of type “best efforts” is sent when no other higher priority data types are available and data of type null is sent when no other data types are available.

7. A method for sending telephony data and other data types from an upstream device to a set of at least two downstream devices on a shared transmission media, the method comprising:
A) concatenating a set of telephony sub-packets addressed for transmission to the downstream devices for use as at least one downstream payload;
B) calculate a time period P for all upstream responses to be sent upstream in response to the set of telephony sub-packets;
C) after an end of a master frame signal,
a. start timer to count to period P;
b. create a first downstream frame identifiable as the start of a master frame; and
c. move a segment from one end of the concatenated set of telephony sub-packets into the payload of the first downstream frame;
D) while any portion of unsent telephony sub-packets exist,
a. move a segment from the same end of the concatenated set of telephony sub-packets into the payload of the next downstream frame; and
b. make the downstream frame identifiable as type continue;
E) after exhausting the concatenated set of telephone sub-packets;
a. while timer is less than P
i. while a supply of video frames for transmission in this master frame exist-transmit video frames to the downstream devices;
ii. else send null frames;
b. After timer greater than P, do until next end of master frame signal:
i. if a supply of low latency IP packets exist-transmit a low latency IP packet in at least one frame to the downstream devices;
ii. else if a supply of video frames for transmission in this master frame exist-transmit a video frame to the downstream devices;
iii. else if at least one best efforts IP packet exists-transmit one best efforts IP packet in at least one frame to the downstream devices;
iv. else transmit a null frame.

8. The method of claim 7 further comprising the steps of: limiting the supply of video frames for transmission in this master frame to a set of video frames queued for delivery to at least one of the downstream devices as of the start this master frame and queuing any subsequent arrivals of video frames for transmission in the next master frame.

9. The method of claim 7 where the telephony sub-packets are TDM PCM telephony sub-packets.

10. The method of claim 7 wherein each of the telephony sub-packets contain an address identifying the unique combination of downstream device and telephone port to which the telephony frame is addressed, and containing a time to respond value used by the downstream device to schedule the upstream telephony transmission for that combination of downstream device and telephone port.

11. The method of claim 10 wherein the receipt of the frame identifiable as the first frame of a master frame initiates a master frame counter in each downstream device.

12. The method of claim 10 wherein the address is a portion of the MAC address of the downstream device and the address excludes a portion of the MAC address for the downstream device that is common to all of the downstream devices on the shared transmission media.

13. The method of claim 7 where the supply of low latency IP packets for use in a particular master frame is limited to preserve a certain portion of each master frame for frames carrying best efforts IP packets.

14. The method of claim 7 where the supply of low latency IP packets for use in a particular master frame is limited to help ensure that the supply of video frames is exhausted within the master frame.

15. The method of claim 7 where the payload size of the downstream frames exceeds the size of a single telephony sub-packet.

16. A modem device for use as one of a set of modem devices at the distal ends of a tree and branch network, the modem device adapted to receive downstream transmissions of a variety of data types on a first frequency and to transmit upstream transmissions of a variety of data types on a second frequency; the modem device adapted to:
Monitor the downstream transmission for the start of a new master frame;
Upon receipt of a the first frame of the new master frame, reset an internal master frame counter;
Receive a set of at least one telephony sub-packet transported downstream in the first set of at least one frame of the master frame;
Recognize any telephony sub-packets addressed to an address associated with that particular modem device;
Discard telephony sub-packets not addressed to a telephone port on that particular modem device; and
Transmit an upstream telephony sub-packet on the upstream frequency in accordance with a time to respond value provided within the downstream telephony sub-packet recognized as addressed to an address associated with that particular modem device.

17. The modem device of claim 16 wherein the modem device recognizes an address that uses a portion of its MAC address that is unique within the set of modem devices on the tree and branch network.

18. The modem device of claim 16 wherein the modem device recognizes an address that distinguishes between at least two telephone ports on the modem device.

19. The modem device of claim 16 that sends upstream frames with an address identification identifying the source of the upstream transmission where the address identification is shorter than the address used for downstream sub-packets addressed to the modem device.

20. The modem device of claim 16 wherein the modem device waits to transmit any other frames on the upstream frequency until after receiving a downstream frame that indicates the end of the time set aside within the master frame for the upstream transmission of telephony by the set of modem devices.

21. The modem device of 16 wherein the response to a detected error in any telephony sub-packet recognized as addressed to an address associated with that particular modem device is to not respond with any upstream transmission so that any potential error in the time to respond value does not lead to contention on the upstream channel with an upstream transmission of a frame from another modem device.

22. A system for transmitting downstream on a first frequency and upstream on a second frequency between an upstream modem device and a set of at least two downstream modem devices on a shared communication media where the data transmitted includes: TDM PCM, MPEG2, low latency IP data, and best efforts data, the system comprising:
A set of at least two downstream modem devices;
A upstream modem device adapted to start a master frame in response to a periodic timing signal;
The master frame starting with a first set of one at least one frame, followed by a second set of at least one frame, then followed by a third set of at least one frame;
The first set of at least one frame carrying at least one payload containing at least one TDM PCM sub-packet addressed to at least one of the downstream modem devices, wherein each of the downstream modem devices reads the each TDM PCM sub-packet to select any TDM PCM sub-packets addressed to that particular downstream modem device;
The first frame in the first set of at least one frame causing each of the downstream modem devices to reset an internal master frame counter;
The second set of at least one frame comprising frames which do not require a response from the downstream modem including at least one MPEG2 frame so that adequate time is provided for the upstream transmission of TDM PCM sub-packets from at least one of the at least two downstream modem devices;
The third set of at least one frame comprising at least one unrestricted frame carrying data selected from the group of data types consisting of low latency IP, MPEG2, best efforts IP, and null frames.

23. The system of 22 wherein the downstream modem devices do not send an upstream response upon recognition of an error in a downstream sub-packet addressed to that particular downstream modem.

24. The system of 22 wherein the unrestricted frames are included into the master frame based on a priority associated with each data type.

25. The system of 24 wherein the unrestricted frames are prioritized such that any frame carrying low latency IP packets is sent before MPEG2 frames, any MPEG2 frame is sent before a frame carrying best effort IP packets, and null frames are sent when no other type is available for transmission.
